(19) United States
(12) Patent Application Publication
(10) Pub. No.: US 2024/0117097 A1
(43) Pub. Date: Apr. 11, 2024

(54) RESIN COMPOSITION FOR THREE-DIMENSIONAL PHOTOSHAPING

(71) Applicant: NAGASE CHEMTEX CORPORATION, Osaka-shi, Osaka (JP)

(72) Inventors: Koji WATANABE, Hyogo (JP); Tatsuya TOKAI, Hyogo (JP)

(21) Appl. No.: 18/262,686

(22) PCT Filed: Jan. 13, 2022
(86) PCT No.: PCT/JP2022/000824

§ 371 Date: Jul. 24, 2023

(30) Foreign Application Priority Data
Jan. 29, 2021 (JP) 2021-013877

(51) Int. Cl. C08F 283/06; B29C 33/38; B29C 33/76; B29C 45/26; B29C 64/35; B33Y 10/00; B33Y 40/20; B33Y 70/00; B33Y 80/00; C08F 283/02; C09D 151/08

(52) U.S. Cl. CPC C08F 283/06; B29C 33/3842; B29C 33/76; B29C 45/26; B29C 64/35; B33Y 10/00; B33Y 40/20; B33Y 70/00; B33Y 80/00; C08F 283/02; C09D 151/08; B29K 2995/007; B29L 2031/757

(57) ABSTRACT

Provided is a resin composition capable of providing a three-dimensionally photofabricated object having high heat resistance while having water solubility. The resin composition is a resin composition for three-dimensional photofabrication containing a reactive monomer, a water-soluble polymer, and a photopolymerization initiator. A cured product of the resin composition has a main tan δ peak temperature of 80° C. or higher. A 1-mm-thick cured product of the resin composition exhibits a remaining thickness of 0.7 mm or smaller after 5-hour immersion in water that is at room temperature.

### TECHNICAL FIELD

The present invention relates to a resin composition for three-dimensional photofabrication and a method for producing a three-dimensionally fabricated object from the resin composition.

### BACKGROUND ART

Three-dimensional printers, especially inkjet 3D printers, often use a water-soluble UV-curable material as a support material. Such a conventional water-soluble UV-curable material is often used with a large amount of water-soluble solvent to maintain the water solubility, which causes low hardness and poor heat resistance. On the other hand, improving the hardness or heat resistance causes poor water solubility.

Patent Literature 1 and Patent Literature 2 disclose resin compositions containing a reactive monomer and a water-soluble polymer. However, these compositions are each intended to be used as a support material to be fabricated together with a modeling material and therefore contain a large amount of water-soluble organic solvent. Further, cured products of these compositions have a low glass transition temperature and thus have low hardness and poor heat resistance.

### CITATION LIST

### Patent Literature

Patent Literature 1: JP 2020-12052 A
Patent Literature 2: WO 2016/121587

### SUMMARY OF INVENTION

### Technical Problem

The present invention aims to provide a resin composition capable of providing a highly heat-resistant three-dimensionally photofabricated object while being soluble in water.

### Solution to Problem

The present inventors studied simultaneous achievement of conflicting properties, i.e., high water solubility and high heat resistance. They then found that a resin composition which contains a reactive monomer, a water-soluble polymer, and a photopolymerization initiator and a cured product of which has a high main tan δ peak temperature while having not a high degree of crosslinking can serve as a resin composition for three-dimensional photofabrication capable of providing a cured product that is soluble in water, completing the present invention.

Specifically, the present invention relates to a resin composition for three-dimensional photofabrication, containing:
a reactive monomer;
a water-soluble polymer; and
a photopolymerization initiator,
a cured product of the resin composition having a main tan δ peak temperature of 80° C. or higher,
a 1-mm-thick cured product of the resin composition exhibiting a remaining thickness of 0.7 mm or smaller after 5-hour immersion in water that is at room temperature.

The reactive monomer is preferably a reactive monomer whose homopolymer has a glass transition temperature of 80° C. or higher.

A cured product of the resin composition preferably has a Shore D hardness of 60 or higher.

The resin composition preferably further contains a divalent metal salt of a carboxylic acid containing a polymerizable functional group.

The present invention also relates to a cured product of the resin composition for three-dimensional photo fabrication.

The cured product is preferably an injection molding core.

The present invention also relates to a method for producing a three-dimensionally fabricated object, the method including:
(i) forming a first liquid film from the resin composition and curing the first liquid film to form a first pattern; and
(ii) forming a second liquid film from the resin composition on the first pattern and curing the second liquid film to add a second pattern.

The method preferably further includes washing the first pattern and the second pattern with a solvent having a Hansen solubility parameter of 25 MPa^{0.5} or lower.

The present invention also relates to a method for storing a cured product, the method including leaving the cured product to stand at a relative humidity of 40 to 60%.

### Advantageous Effects of Invention

The resin composition for three-dimensional photofabrication of the present invention can provide a three-dimensionally photofabricated object that simultaneously achieves conflicting properties, i.e., water solubility and high heat resistance.

### BRIEF DESCRIPTION OF DRAWINGS

FIG. 1 includes schematic diagrams illustrating the steps of forming an object by photofabrication using a resin composition for three-dimensional photofabrication according to an embodiment of the present invention.

### DESCRIPTION OF EMBODIMENTS

The resin composition for three-dimensional photofabrication of the present invention contains a reactive monomer, a water-soluble polymer, and a photopolymerization initiator, a cured product of the resin composition has a main tan δ peak temperature of 80° C. or higher, and a 1-mm-thick cured product of the resin composition exhibits a remaining thickness of 0.7 mm or smaller after 5-hour immersion in water that is at room temperature.

The reactive monomer is preferably a monomer such that a homopolymer of the reactive monomer has a glass transition temperature of 80° C. or higher. The glass transition temperature is preferably 85° C. or higher, more preferably 100° C. or higher. A glass transition temperature of lower than 80° C. indicates poor heat resistance. The glass transition temperature may be measured using a homopolymer actually produced or may be calculated by the group contribution method.

The reactive monomer is a photo-curable monomer that is curable or polymerizable by the action of radicals or ions generated by light application. The photo-curable monomer is preferably a monomer containing a polymerizable functional group. The number of polymerizable functional groups in the photo-curable monomer is preferably 1 to 8. Examples of the polymerizable functional group include groups containing a polymerizable carbon-carbon unsaturated bond, such as a vinyl group and an allyl group, and an epoxy group.

Specific examples thereof include radical polymerizable monomers such as a (meth)acrylic monomer and cation polymerizable monomers such as an epoxy monomer, a vinyl monomer, and a diene monomer. In terms of the reaction rate, preferred are a (meth)acrylic monomer and a vinyl monomer. In order to prevent a high crosslink density, preferred are a monofunctional (meth)acrylic monomer and a monofunctional vinyl monomer.

Examples of the (meth)acrylic monomer include monomers containing a (meth)acryloyl group. Examples thereof include monofunctional monomers, including methacrylic acid esters such as methyl (meth)acrylate, ethyl (meth)acrylate, n-butyl (meth)acrylate, isobutyl (meth)acrylate, t-butyl (meth)acrylate, neopentyl (meth)acrylate, cyclohexyl (meth)acrylate, benzyl (meth)acrylate, octyl (meth)acrylate, lauryl (meth)acrylate, stearyl (meth)acrylate, cetyl (meth)acrylate, ethylcarbitol (meth)acrylate, hydroxyethyl (meth)acrylate, hydroxypropyl (meth)acrylate, hydroxybutyl (meth)acrylate, methoxyethyl (meth)acrylate, and methoxybutyl (meth)acrylate, and (meth)acrylic acid amides such as N-methyl (meth)acrylamide, N-ethyl (meth)acrylamide, N-propyl (meth)acrylamide, N-isopropyl (meth)acrylamide, N-butoxymethyl (meth)acrylamide, N-t-butyl (meth)acrylamide, N-octyl (meth)acrylamide, N,N-dimethyl (meth)acrylamide, N,N-diethyl (meth)acrylamide, (meth)acryloyl morpholine, and diacetone (meth)acrylamide; monofunctional monomers such as styrene, methyl itaconate, ethyl itaconate, vinyl acetate, vinyl propionate, N-vinyl pyrrolidone, N-vinylcaprolactam, and 3-vinyl-5-methyl-2-oxazolidinone; and multifunctional monomers such as 1,4-butanediol di(meth)acrylate, 1,6-hexanediol di(meth)acrylate, 1,9-nonanediol di(meth)acrylate, 2-n-butyl-2-ethyl-1,3-propanediol di(meth)acrylate, tripropylene glycol di(meth)acrylate, tetraethylene glycol di(meth)acrylate, methylenebisacrylamide, trimethylolpropane tri(meth)acrylate, and pentaerythritol tri(meth)acrylate. In terms of the reaction rate, preferred among these are (meth)acrylic acid amides. Preferred among the (meth)acrylic acid amides are (meth)acryloyl morpholine, N,N-dimethyl (meth)acrylamide, N,N-diethyl (meth)acrylamide, and dimethylaminopropyl acrylamide. Herein, acrylic acid and methacrylic acid are collectively referred to as (meth)acrylic acid, and acrylic acid ester (or acrylate) and methacrylic acid ester (or methacrylate) are also collectively referred to as (meth)acrylic acid ester (or (meth)acrylate).

Examples of the vinyl monomer include vinyl ethers such as polyol poly(vinyl ether), aromatic vinyl monomers such as styrene, and vinylalkoxysilanes. An example of the polyol constituting the polyol poly(vinyl ether) is a polyol (butane diol) mentioned with regard to the acrylic monomer. Examples of the diene monomer include isoprene and butadiene.

Examples of the epoxy monomer include compounds having two or more epoxy groups in the molecule. Examples of the epoxy monomer include compounds having an epoxy cyclohexane ring or a 2,3-epoxypropyloxy group.

The reactive monomer in the resin composition for three-dimensional photofabrication of the present invention is contained in an amount of preferably, but not limited to, 99.5 to 1% by mass, more preferably 90 to 60% by mass. Less than 1% by mass of the reactive monomer tends to cause high viscosity of the resin, while more than 99.5% by mass thereof tends to cause high cure shrinkage.

The photopolymerization initiator is activated by the action of light to initiate polymerization of the reactive monomer. Examples of the photopolymerization initiator include radical polymerization initiators that generate radicals by the action of light as well as those generating bases (or anions) or acids (or cations) by the action of light (specifically, anion generators and cation generators). The photopolymerization initiator can be selected according to the type of the photocurable monomer, e.g., whether the photocurable monomer is radically polymerizable or ionically polymerizable. Examples of a radical polymerization initiator (radical photopolymerization initiator) include an alkylphenone photopolymerization initiator and an acylphosphine oxide photopolymerization initiator.

Examples of the alkylphenone polymerization initiator include 2,2-dimethoxy-1,2-diphenylethan-1-one, 1-hydroxy-cyclohexyl-phenyl-ketone, 2-hydroxy-2-methyl-1-phenyl-propan-1-one, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 2-methyl-1-(4-methylthiophenyl)-2-morpholinopropan-1-one, 2-benzyl-2-dimethylamino-1-(4-morpholinophenyl)-butanone-1, and 2-(dimethylamino)-2-[(4-methylphenyl)methyl]-1-[4-(4-morpholinyl)phenyl]-1-butanone.

Examples of the acylphosphine oxide polymerization initiator include 2,4,6-trimethylbenzoyl-diphenyl-phosphine oxide and bis(2,4,6-trimethylbenzoyl)-phenylphosphine oxide.

The photopolymerization initiator is added in an amount of preferably 0.01 to 10 parts by weight, more preferably 0.1 to 5 parts by weight relative to 100 parts by weight of the reactive monomer. Less than 0.01 parts by weight of the photopolymerization initiator tends to cause poor curing, while more than 10 parts by weight thereof tends to cause poor storage stability and poor curing due to absorption.

The water-soluble polymer is a polymer that swells or dissolves in water. Examples thereof include polyalkylene glycols, polyvinyl alcohol, modified polyvinyl alcohols such as polyvinyl alcohol-polyacrylate block copolymers and grafted polyvinyl alcohols, polyester, hydroxymethyl cellulose, hydroxyethyl cellulose, hydroxypropyl cellulose, polyvinylpyrrolidone, vinylpyrrolidone-vinylimidazole copolymers, water-soluble alkyd resin, salts (e.g., sodium salt, amine salt) of copolymers derived from (meth)acrylic acid, and water-soluble polymers containing an ethylenic double bond in a side chain.

The water-soluble polymer has a weight average molecular weight of preferably, but not limited to, 500 to 1000000, more preferably 500 to 100000. A water-soluble polymer having a weight average molecular weight of greater than 1000000 tends to cause poor water solubility of a cured product or significantly poor solubility in the monomers.

The reactive monomer and the water-soluble polymer are blended at a weight ratio of preferably 99.5/0.5 to 1/99, more preferably 60/40 to 95/5. The reactive monomer at a proportion of greater than 99.5 tends to cause high cure shrinkage, while the reactive monomer at a proportion of lower than 1 tends to cause high viscosity of the resin.

The water-soluble polymer in the resin composition for three-dimensional photofabrication of the present invention is contained in an amount of preferably, but not limited to, 0.5 to 99% by mass, more preferably 5 to 40% by mass. Less than 0.5% by mass of the water-soluble polymer tends to cause high cure shrinkage, while more than 99% by mass thereof tends to cause high viscosity of the resin.

The resin composition preferably further contains a divalent metal salt of a carboxylic acid containing a polymerizable functional group. The presence of this metal salt can improve the heat resistance. An example of the polymerizable functional group is a (meth)acryl group. Examples of the metal salt include magnesium salts, zinc salts, and calcium salts. Specific examples thereof include magnesium (meth)acrylate, zinc (meth)acrylate, and calcium (meth)acrylate.

The divalent metal salt of a carboxylic acid containing a polymerizable functional group is added in an amount of preferably 1 to 10 parts by weight, more preferably 2 to 5 parts by weight relative to 100 parts by weight in total of the reactive monomer and the water-soluble polymer. Less than 1 part by weight of the divalent metal salt may cause insufficient heat resistance, while more than 10 parts by weight thereof tends to cause poor monomer solubility.

The resin composition may further contain a different known curable resin, for example. The curable resin composition may also contain any known additives such as a dye, an ultraviolet sensitizer, a polymerization inhibitor, a plasticizer, an ultraviolet absorber, a pigment, and a surfactant.

The resin composition is preferably in the form of liquid at room temperature. The resin composition in the form of liquid at room temperature can be easily subjected to photofabrication using a 3D printer, for example. The curable resin composition has a viscosity at 25° C. of preferably 5000 mPa·s or lower, more preferably 2000 mPa·s or lower. The viscosity of the resin composition can be measured using an E-type, i.e., cone and plate viscometer at a rotational speed of 20 rpm.

A cured product of the resin composition for three-dimensional photofabrication of the present invention has a main tan δ peak temperature of 80° C. or higher, preferably 100° C. or higher, more preferably 120° C. or higher. A main tan δ peak temperature of lower than 80° C. causes insufficient heat resistance. The tan δ is a Tg value measured using a dynamic mechanical analyzer (DMA). The measurement can be performed while the temperature of the cured product is increased from a low temperature to a high temperature (e.g., from −100° C. to +200° C.). If there are multiple peaks, the temperature of the highest peak (main peak) is taken as the tan δ.

A cured product of the resin composition for three-dimensional photofabrication of the present invention has an initial deformation temperature of preferably 30° C. or higher, more preferably 50° C. or higher, still more preferably 80° C. or higher. An initial deformation temperature of lower than 30° C. may cause poor heat resistance. The initial deformation temperature is the temperature at 1% strain measured using a dynamic mechanical analyzer (DMA). The measurement can be performed while the temperature of the cured product is increased from a low temperature to a high temperature (e.g., from −100° C. to +200° C.).

A 1-mm-thick cured product of the resin composition for three-dimensional photofabrication of the present invention exhibits a remaining thickness of 0.7 mm or smaller, preferably 0.5 mm or smaller, more preferably 0 mm (i.e., complete dissolution) after 5-hour immersion in water that is at room temperature. A remaining thickness of greater than 0.7 mm indicates insufficient water solubility.

A cured product of the resin composition for three-dimensional photofabrication of the present invention has a Shore D hardness of 60 or higher, preferably 70 or higher, more preferably 80 or higher. A Shore D hardness of lower than 60 tends to cause insufficient strength. The Shore D hardness is measured in conformity with JIS K7215:1986 using a type D durometer.

A cured product of the resin composition for three-dimensional photofabrication of the present invention has an elastic modulus Er at 80° C. of preferably 0.01 GPa or higher, more preferably 0.1 GPa or higher, still more preferably 1 GPa or higher. An elastic modulus Er of lower than 0.01 GPa causes insufficient strength. The elastic modulus Er at 25° C. is preferably 0.1 GPa or higher, more preferably 1 GPa or higher. A cured product having an elastic modulus Er at 25° C. of lower than 0.1 GPa has insufficient strength. The elastic modulus Er can be measured using a rheometer.

The resin composition for three-dimensional photofabrication of the present invention can be formed into 2D or 3D objects (or patterns) by a variety of fabricating methods and is particularly suitable for photofabrication. The resin composition for three-dimensional photofabrication is in the form of liquid at room temperature and may therefore be used for vat-type photofabrication or inkjet-type photofabrication, for example.

The method for producing a three-dimensionally fabricated object of the present invention includes:
(i) forming a first liquid film from the resin composition for three-dimensional photofabrication of the present invention and curing the first liquid film to form a first pattern; and
(ii) forming a second liquid film from the resin composition for three-dimensional photofabrication of the present invention on the first pattern and curing the second liquid film to add a second pattern.

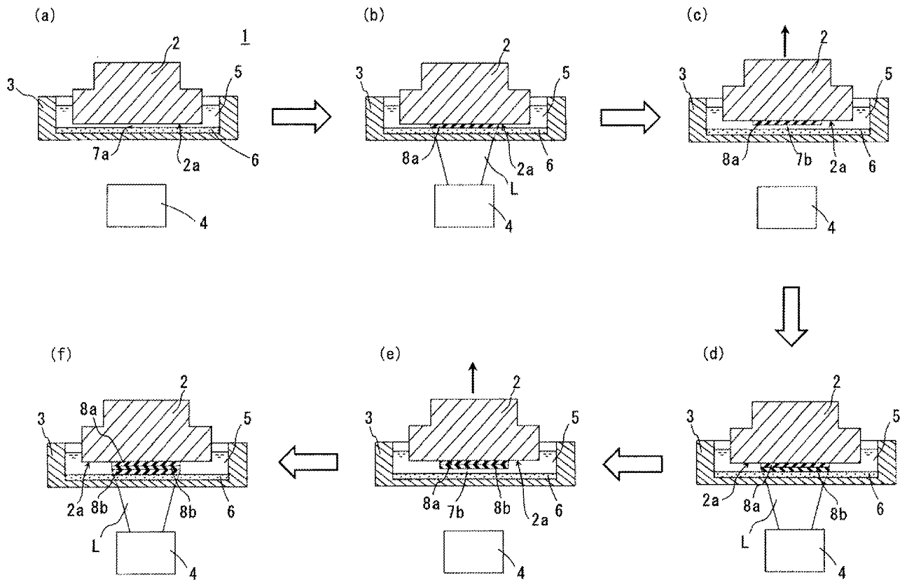

With reference to FIG. 1, the following describes the procedures of vat-type photofabrication. FIG. 1 illustrates an example of forming a three-dimensionally fabricated object using a photofabrication device (patterning device) including a resin tank (vat). This illustrated example shows bottom-up fabrication, but any method is applicable in which a resin composition is used for three-dimensional photofabrication. Also, light application (light exposure) is performed by any technique and may be performed by either spot exposure or area exposure.

A photofabrication device 1 includes a platform 2 including a pattern-forming surface 2a, a resin tank 3 containing a curable resin composition 5, and a projector 4 as an area-exposure light source.

(i) Step of Forming and Curing First Liquid Film to Form First Pattern

In the step (i), as shown in FIG. 1(a), the pattern-forming surface 2a of the platform 2 is first immersed in the curable resin composition 5 in the resin tank 3 while facing the projector 4 (the bottom of the resin tank 3). In this step, the level of the pattern-forming surface 2a (or the platform 2) is adjusted so that a liquid film 7a (liquid film a) is formed between the pattern-forming surface 2a and the projector 4 (or the bottom of the resin tank 3). Next, as shown in FIG. 1(b), light L is applied (in an area exposure manner) from the projector 4 to the liquid film 7a to photocure the liquid film 7a, whereby a first pattern 8a (pattern a) is formed.

In the photofabrication device 1, the resin tank 3 serves as a supply unit for the curable resin composition 5. In order to apply light from the light source to the liquid film, at least a portion of the resin tank between the liquid film and the projector 4 (the bottom in FIG. 1) is preferably transparent to the exposure wavelength. The shape, material, size, and the like of the platform 2 are not limited.

After the liquid film a is formed, light is applied from the light source to the liquid film a so that the liquid film a is photocured. The light application can be performed by a known method. The light application may be performed by any technique and may be performed by either spot exposure or area exposure. The light source used may be a known light source used for photocuring. In the case of spot exposure, examples of the light source include a plotter, a galvanometer laser (or galvanometer scanner), and a stereolithography (SLA) device. In the case of area exposure, the light source is preferably a projector in terms of simplicity. Examples of the projector include an LCD (transmission liquid crystal) projector, an LCoS (reflective liquid crystal) projector, and a digital light processing (DLP®) projector. The exposure wavelength can be selected as appropriate according to the components (in particular, the type of the initiator) of the curable resin composition.

(ii) Step of Forming Second Liquid Film on First Pattern and Curing Second Liquid Film to Add Second Pattern

In the step (ii), the curable resin composition is supplied between the pattern a obtained in the step (i) and the light source and a liquid film (liquid film b) is formed therebetween. In other words, the liquid film b is formed on the pattern a provided on the pattern-forming surface. The curable resin composition is supplied in the same manner as in the step (i).

For example, as shown in FIG. 1(c), after the first pattern 8a (2D pattern a) is formed, the first pattern-forming surface 2a may be raised together with the entire platform 2. The curable resin composition 5 is then supplied between the first pattern 8a and the bottom of the resin tank 3, whereby a liquid film 7b (liquid film b) is formed therebetween.

Light is applied from the light source to the resulting liquid film b so that the liquid film b is photocured, whereby another pattern (a pattern b obtained by photocuring the liquid film b) is added on the first pattern a. Such patterns are stacked in the thickness direction, whereby a three-dimensionally fabricated pattern is formed.

For example, as shown in FIG. 1(d), light is applied from the projector 4 to the liquid film 7b (liquid film b) provided between the first pattern 8a (pattern a) and the bottom of the resin tank 3 so that the liquid film 7b is photocured. This photocuring converts the liquid film 7b into a second pattern 8b (pattern b). In this manner, the second pattern 8b is stacked on the first pattern 8a. With respect to the light source, exposure wavelength, and other factors, reference may be made to the description of the step (i).

The step (ii) may be repeated multiple times. Repetition allows for stacking of multiple patterns b in the thickness direction, resulting in a more stereoscopically fabricated pattern. The number of repetitions can be determined as appropriate according to the shape, size, and other factors of a desired three-dimensionally fabricated object (three-dimensionally fabricated pattern).

For example, as shown in FIG. 1(e), the platform 2 is raised with the first pattern 8a (pattern a) and the second pattern 8b (pattern b) being stacked on the pattern-forming surface 2a. In this step, a liquid film 7b (liquid film b) is formed between the second pattern 8b and the bottom of the resin tank 3. Then, as shown in FIG. 1(f), light is applied from the projector 4 to the liquid film 7b so that the liquid film 7b is photocured. Thereby, another pattern 8b (pattern b) is formed on the second pattern 8b. Alternate repetition of the steps (e) and (f) allows for stacking of multiple patterns 8b (2D patterns b).

The method for producing a three-dimensionally fabricated object of the present invention preferably further includes washing the first pattern and the second pattern with a solvent. Since the three-dimensionally fabricated pattern obtained has uncured residues of the curable resin composition attached thereto, the washing is performed to remove the composition. The solvent is preferably one having a Hansen solubility parameter of 25 MPa^{0.5} or lower. A specific example of the solvent is 3-methoxy-3-methyl-1-butanol.

The resulting three-dimensionally fabricated pattern may be subjected to post-curing, if necessary. Post-curing may be performed by applying light to the pattern. The conditions of the light application may be adjusted as appropriate according to the type of the resin composition or the degree of curing of the resulting pattern, for example. Post-curing may be performed on a portion of the pattern or on the whole of the pattern.

A three-dimensionally fabricated object obtained from a cured product of the resin composition for three-dimensional photofabrication of the present invention and a three-dimensionally fabricated object obtained by the method for producing a three-dimensionally fabricated object of the present invention can be used for various applications. Owing to their excellent water solubility and heat resistance, they can suitably be used as modeling material. For example, each of these may be used as a sacrificial mold, an injection mold, a casting mold, or the like. Examples of the sacrificial mold include an injection molding core and a sacrificial mold for thermosetting resin.

The sacrificial mold for thermosetting resin is formed from a cured product of the resin composition for three-dimensional photofabrication and used for curable resins. The sacrificial mold for a curable resin is a mold that is dissolved and removed after the curable resin is cured and molded. Examples of the curable resin include urethane resin, epoxy resin, silicone resin, phenol resin, urea resin, melamine resin, unsaturated polyester resin, diallyl phthalate resin, acrylic resin, and alkyd resin. The curable resin used may be either a photocurable resin or a thermosetting resin.

The method for storing a cured product of the present invention includes leaving the cured product to stand at a relative humidity of 40 to 60%. A relative humidity of lower than 40% may cause loss of moisture in the cured product and subsequent cracking in the cured product. A relative humidity of higher than 60% may cause moisture absorption and subsequent changes in properties of the material. The storage temperature is preferably, but not limited to, 15° C. to 40° C.

### EXAMPLES

The present invention is described below with reference to examples. The present invention is not limited to the following examples. Hereinafter, the terms “part(s)” and “%” represent “part(s) by weight” and “% by weight”, respectively, unless otherwise specified.

The chemicals used in the examples and comparative examples are listed below.

### <<Monofunctional Acrylate>>

Acryloyl morpholine (ACMO): Tg of homopolymer 144° C., available from KJ Chemicals, Corp.
3-Vinyl-5-methyl-2-oxazolidinone (VMOX): Tg of homopolymer 173° C., available from BASF
Dimethyl acrylamide (DMAA): Tg of homopolymer 119° C., available from KJ Chemicals, Corp.

### <<Bifunctional Acrylate>>

PEG200 diacrylate (Light Acrylate 4EG-A): Tg of cured product 50° C., available from Kyoeisha Chemical Co., Ltd.
PEG400 diacrylate (Light Acrylate 9EG-A): Tg of cured product −9° C., available from Kyoeisha Chemical Co., Ltd.

### <<Water-Soluble Polymer>>

PEG600: Tm 15° C. to 25° C., weight average molecular weight 560 to 640, available from Fujifilm Wako Pure Chemicals Corp.
PEG #4000: weight average molecular weight 3100, available from NOF Corp.
Polyvinylpyrrolidone (PVP K-15): Tg 120° C., weight average molecular weight 6000 to 15000, available from Ashland Japan Ltd.
Polyester (Plas Coat Z-221-100(F)): weight average molecular weight 14000, available from Goo Chemical Co., Ltd.

### <<Divalent Metal Salt of Carboxylic Acid Having Polymerizable Functional Group>>

Magnesium acrylate: MA90, available from Asada Chemical Industry Co. Ltd.
Zinc acrylate: ZDA-90, available from Asada Chemical Industry Co. Ltd.

### <<Photopolymerization Initiator>>

2,4,6-Trimethylbenzoyl-diphenyl-phosphine oxide (Omnirad TPO-H): available from IGM Resins B.V.
Bis(2,4,6-trimethylbenzoyl)-phenylphosphine oxide (Omnirad 819): available from IGM Resins B.V.

### Examples 1 to 9 and Comparative Examples 1 to 3

Components including a reactive monomer(s), a water-soluble polymer, and a photopolymerization initiator were mixed with each other in amounts shown in Table 1 and were heated in an 80° C. oven under stirring, so that the solid components were dissolved. Thereby, a uniform liquid resin composition was prepared. The resulting resin composition was used for the following evaluations. The evaluation results are shown in Table 1.

### <Tan δ Peak Temperature, Elastic Modulus Er, and Initial Deformation Temperature>

About 1 g portions of the respective resin compositions prepared in the examples and the comparative examples were each sandwiched between glass plates. Each workpiece was irradiated with light at 7 mW/cm² using a UV irradiator (available from Aitec System Co., Ltd.) every 60 seconds, thereby providing a glass plate including, on one side, a cured product having a thickness of about 1 mm. The resulting sample was heated from −100° C. to +200° C. at a frequency of 1 Hz and a temperature-increasing rate of 5° C./min using DVA-2000 (available from IT Keisoku Seigyo, Co., Ltd.). The elastic moduli Er at 25° C. and 80° C. were determined and the temperature at which the tan δ reached its top peak was determined as Tg of the cured product of the resin composition. In the cases where multiple peaks were present at which the tan δ reached its local maximum, the peak temperature of the highest peak (Tg of the polymer serving as a matrix) was taken as Tg. The temperature at 1% elongation was taken as the initial deformation temperature.

### <Water Solubility>

According to the method described in <Tan δ peak temperature, elastic modulus Er, and initial deformation temperature>, a glass plate including on one side a cured product having a thickness of about 1 mm was produced. After 5-hour immersion in 100 g of water that was at room temperature, the film thickness was measured. The film thickness was evaluated by the following evaluation criteria.
Good: film thickness of 0.7 mm or smaller
Poor: film thickness of greater than 0.7 mm

### <Shore D Hardness>

Using an LCD-type 3D printer (Phrozen Shuffle XL, available from Phrozen Technology), a strip-shaped sample (length 35 mm×width 20 mm×thickness (height) 6 mm) was formed under conditions including an irradiation time per layer of 5 seconds and a z-axis (height direction) pitch of 50 μm. The Shore D hardness was measured using a Type D durometer in conformity with JIS K7215:1986.

TABLE 1

| | | | | Comparative Example | | | Example | | |
|---|---|---|---|---|---|---|---|---|---|
| Example No. | | | | 1 | 2 | 3 | 1 | 2 | 3 |
| Composition | Reactive | Monofunctional | ACMO | 50 | 75 | 75 | 75 | 75 | |
| | monomer | acrylate | VMOX | | | | | | 85 |
| | | | DMAA | | | | | | |
| | | Bifunctional | 4EG-A | | 10 | | | | |
| | | acrylate | 9EG-A | | | 10 | | | |

| | | | | | | | | |
|---|---|---|---|---|---|---|---|---|
| | Water-soluble | PEG600 | 50 | 15 | 15 | 25 | | |
| | polymer | PEG#4000 | | | | | | |
| | | PVP K-15 | | | | | 25 | 15 |
| | | Z-221-100(F) | | | | | | |
| | Metal carboxylate | MA90 | | | | | | |
| | | ZDA-90 | | | | | | |
| | Photopolymerization | Omnirad TPO-H | 3 | | | | 3 | 3 |
| | initiator | Omnirad 819 | | 3 | 3 | 3 | | |
| Evaluation | Tanδ | Peak temperature (° C.) | 57 | 104 | 100 | 93 | 151 | 147 |
| results | Er (Pa) | 25° C. | 1.0E+08 | 1.1E+09 | 4.7E+08 | 4.5E+08 | 1.8E+09 | 1.6E+09 |
| | | 80° C. | Unmeasurable | 3.1E+08 | 1.2E+08 | 4.3E+06 | 1.0E+09 | 6.0E+08 |

| Initial deformation temperature (° C.) | −7 | — | — | — | 54 | — |
|---|---|---|---|---|---|---|
| Water solubility | Good | Poor | Poor | Good | Good | Good |
| | | (gelled) | (gelled) | | | |
| | 0 mm | — | — | 0 mm | 0 mm | 0 mm |
| Shore D hardness | — | — | — | 64 | 82 | — |

| | | | | Example | | | | | |
|---|---|---|---|---|---|---|---|---|---|
| Example No. | | | | 4 | 5 | 6 | 7 | 8 | 9 |
| Composition | Reactive | Monofunctional | ACMO | | 95 | 85 | 75 | | |
| | monomer | acrylate | VMOX | | | | | | |
| | | | DMAA | 85 | | | | 85 | 85 |
| | | Bifunctional | 4EG-A | | | | | | |
| | | acrylate | 9EG-A | | | | | | |

| | | | | | | | | |
|---|---|---|---|---|---|---|---|---|
| | Water-soluble | PEG600 | | | | | | |
| | polymer | PEG#4000 | | | 15 | | | |
| | | PVP K-15 | 15 | | | 25 | 15 | 15 |
| | | Z-221-100(F) | | 5 | | | | |
| | Metal carboxylate | MA90 | | | | 2 | | 2 |
| | | ZDA-90 | | | | | 2 | |
| | Photopolymerization | Omnirad TPO-H | 3 | 3 | 3 | 3 | 3 | 3 |
| | initiator | Omnirad 819 | | | | | | |
| Evaluation | Tanδ | Peak temperature (° C.) | 120 | 159 | 164 | 164 | 131 | 129 |
| results | Er (Pa) | 25° C. | 1.9E+09 | 1.9E+09 | 1.9E+09 | 1.8E+09 | 1.2E+09 | 1.9E+09 |
| | | 80° C. | 1.3E+09 | 1.4E+09 | 1.2E+09 | 1.5E+09 | 1.0E+09 | 1.3E+09 |

| Initial deformation temperature (° C.) | 49 | — | — | 89 | 82 | 86 |
|---|---|---|---|---|---|---|
| Water solubility | Good | Good | Good | Good | Good | Good |
| | 0 mm | 0 mm | 0.02 mm | 0 mm | 0 mm | 0 mm |
| Shore D hardness | — | — | — | — | — | — |

Table 1 demonstrates that the resin compositions of Examples 1 to 9 had a high main tan δ peak temperature, a high elastic modulus at 80° C., and good water solubility. In contrast, the resin composition of Comparative Example 1 had a low main tan δ peak temperature, and the elastic modulus was unmeasurable at 80° C. The resin compositions of Comparative Examples 2 and 3 had a low main tan δ peak temperature and a high elastic modulus at 80° C. but were gelled and had no water solubility.

### <Washability>

The resin composition prepared in Example 2 was evaluated for the washability as follows. A 1-g portion of the composition before curing was immersed in 100 ml of ethanol or 3-methoxy-3-methyl-1-butanol (Solfit FG, available from Kuraray Co., Ltd.) for 10 minutes at room temperature, and whether the composition was dissolved or not was visually evaluated. A strip-shaped cured product prepared according to the method described in <Shore D hardness> was immersed in 100 ml of ethanol or 3-methoxy-3-methyl-1-butanol for 10 minutes at room temperature. The cured product was then evaluated for the degree of stickiness and the appearance respectively by touch and visual inspection.

As a result, a conventional solvent having a Hansen solubility parameter of 27 MPa^{0.5}, i.e., ethanol, completely dissolved the composition before curing, but made the cured product sticky and cloudy. In contrast, a solvent having a Hansen solubility parameter of 20.2 MPa^{0.5}, i.e., 3-methoxy-3-methyl-1-butanol, completely dissolved the composition before curing and made the cured product slightly sticky, but kept it transparent. Thus, a solvent having a Hansen solubility parameter of 20.2 MPa^{0.5}, i.e., Solfit FG, was found to be an excellent washing solvent.

### <Storageability>

Using an LCD-type 3D printer (available from Phrozen Technology, Phrozen Shuffle XL), the resin composition prepared in Example 2 was formed into a strip-shaped sample (length 35 mm×width 20 mm×thickness (height) 6 mm) under conditions including an irradiation time per layer of seconds and a z-axis (height direction) pitch of 50 μm. Ten-minute post-curing was performed on each of the front and back surfaces. The resulting fabricated object was stored at the temperature and the humidity shown in Table 2 for the period shown in Table 2. The weights before and after storage and the Shore D hardness were measured by the aforementioned method. The appearance after storage was evaluated by the following criteria. The Shore D hardness after storage at a temperature of 85° C. and a humidity of 85% was not measured because the sample failed to retain the shape.
Good: no cracking occurred
Fair: partial cracking occurred
Poor: shape was not retained

TABLE 2

| | | | | |
|---|---|---|---|---|
| Before | Weight (g) | 5.3545 | 5.3669 | 5.3570 |
| storage | Shore D hardness | 82 | 82 | 82 |
| Storage | Temperature | 23° C. | 23° C. | 85° C. |
| conditions | Relative humidity | 41% | 27% | 85% |
| | Period | 7 Days | 7 Days | 0.5 Days |
| After | Weight (g) | 5.4202 | 5.3875 | 5.7652 |
| storage | Weight change | 1.2% | 0.4% | 7.6% |
| | Shore D | 82 | 82 | Not measured |
| | Shore D change | ±0 | ±0 | — |
| | Appearance | Good | Fair | Poor |

Cracking occurred at a temperature of 23° C. and a relative humidity of 27%. In contrast, no cracking occurred at a relative humidity of 41%, which means appropriate storage. The object failed to retain its shape at a temperature of 85° C. and a relative humidity of 85% and therefore the Shore D hardness thereof was not measured.

### REFERENCE SIGNS LIST

1: photofabrication device
2: platform
2a: pattern-forming surface
3: resin tank
4: projector
5: curable resin composition
6: release agent layer
7a: liquid film a
7b: liquid film b
8a: first pattern a
8b: second pattern b
L: light

1. A resin composition for three-dimensional photofabrication, comprising:
a reactive monomer;
a water-soluble polymer; and
a photopolymerization initiator,
a cured product of the resin composition having a main tan δ peak temperature of 80° C. or higher,
a 1-mm-thick cured product of the resin composition exhibiting a remaining thickness of 0.7 mm or smaller after 5-hour immersion in water that is at room temperature,
wherein the reactive monomer is a reactive monomer whose homopolymer has a glass transition temperature of 80° C. or higher, and
wherein the water-soluble polymer is a polymer selected from the group consisting of polyalkylene glycols, polyvinyl alcohol, modified polyvinyl alcohols, polyester, hydroxymethyl cellulose, hydroxyethyl cellulose, hydroxypropyl cellulose, polyvinylpyrrolidone, vinylpyrrolidone-vinylimidazole copolymers, water-soluble alkyd resin, salts of copolymers derived from (meth)acrylic acid, and water-soluble polymers containing an ethylenic double bond in a side chain.

2. (canceled)

3. The resin composition for three-dimensional photofabrication according to claim 1,
wherein a cured product of the resin composition has a Shore D hardness of 60 or higher.

4. The resin composition for three-dimensional photofabrication according to claim 1, further comprising:
a divalent metal salt of a carboxylic acid containing a polymerizable functional group.

5. A cured product of the resin composition for three-dimensional photofabrication according to claim 1.

6. The cured product according to claim 5,
wherein the cured product is an injection molding core.

7. A method for producing a three-dimensionally fabricated object, the method comprising:
(i) forming a first liquid film from the resin composition according to claim 1 and curing the first liquid film to form a first pattern; and
(ii) forming a second liquid film from the resin composition according to claim 1 on the first pattern and curing the second liquid film to add a second pattern.

8. The method for producing a three-dimensionally fabricated object according to claim 7, further comprising:
washing the first pattern and the second pattern with a solvent having a Hansen solubility parameter of 25 MPa^{0.5} or lower.

9. A method for storing a cured product, the method comprising:
leaving the cured product according to claim 5 to stand at a relative humidity of 40 to 60%.
